(19) United States
(12) Patent Application Publication
(10) Pub. No.: US 2025/0105731 A1
(43) Pub. Date: Mar. 27, 2025

(54) RESONANT CONVERTER WITH CURRENT SENSING CIRCUIT

(71) Applicant: Chengdu Monolithic Power Systems Co., Ltd., Chengdu (CN)

(72) Inventors: Xu Han, Hangzhou (CN); Ting Ge, San Jose, CA (US); Fengchun He, Hangzhou (CN); Junjie Feng, San Jose, CA (US); Jinghai Zhou, Bellevue, WA (US)

(21) Appl. No.: 18/891,835

(22) Filed: Sep. 20, 2024

(30) Foreign Application Priority Data
Sep. 21, 2023 (CN) 202311227433.6

(51) Int. Cl. H02M 3/00; H02M 1/00; H02M 3/335

(52) U.S. Cl. CPC H02M 3/01; H02M 1/0009; H02M 3/33573; H02M 1/0048

(57) ABSTRACT

A resonant converter has a first transistor, a second transistor, a third transistor, a fourth transistor, a transformer, a resonant tank, a rectifier circuit and a current sensing circuit. The transformer comprises a primary winding and a first sampling winding at a primary side, and a secondary winding at a secondary side. The resonant tank circuit is coupled between the first switching node and the second switching node and comprises a resonant capacitor, a resonant inductor and a magnetizing inductance of the primary winding coupled in series. The rectifier circuit is coupled between the first end of the secondary winding and the second end of the secondary winding. The current sensing circuit is used to receive the first capacitor voltage sampling signal and provide a current sensing signal based on the first capacitor voltage sampling signal.

### CROSS-REFERENCE TO RELATED APPLICATIONS

This application claims the benefit of CN application No. 202311227433.6, filed on Sep. 21, 2023, and incorporated herein by reference.

### BACKGROUND OF THE INVENTION

### 1. Field of the Invention

The present invention generally relates to electronic circuits, and more particularly but not exclusively relates to resonant converters.

### 2. Description of Related Art

A resonant converter (such as an LLC resonant converter) is a conversion circuit that applies a resonant tank circuit. The resonant converter regulates a direct current (DC) input voltage and converts the DC input voltage to a DC output voltage.

The resonant converter typically has a switching bridge circuit for converting the DC input voltage into a square wave signal, and the switching bridge circuit may be a switching half-bridge circuit or a switching full-bridge circuit. The resonant tank circuit receives the square wave signal and generates an approximately sinusoidal resonant current and provides the resonant current to a rectifier via a transformer. An output capacitor filters an output of the rectifier to provide the DC output voltage.

The resonant tank circuit typically includes a resonant capacitor, a resonant inductor, and a magnetizing inductance of a primary winding of the transformer coupled in series. In prior arts, sensing of the resonant current is mostly performed by employing a current transformer or connecting a sensing resistor in series in the resonant converter. However, the current transformer leads to high cost, and the sensing resistor induces large power loss.

### SUMMARY OF THE INVENTION

It is one of the objects of the present invention to provide a resonant converter with a current sensing circuit.

One embodiment of the present invention discloses a resonant converter. The resonant converter comprises a first transistor, a second transistor, a third transistor and a fourth transistor, a transformer, a resonant tank circuit, a rectifier circuit, and a current sensing circuit. Each of the second, third and fourth transistors have a first end and a second end. The first end of the first transistor and the first end of the third transistor are coupled to a DC input voltage. The second end of the first transistor is coupled to the first end of the second transistor to form a first switching node. The second end of the third transistor is coupled to the first end of the fourth transistor to form a second switching node. The transformer comprises a primary winding and a first sampling winding at a primary side, and a secondary winding at a secondary side. Each of the primary winding, the first sampling winding and the secondary winding has a first end and a second end. The resonant tank circuit comprises a resonant capacitor, a resonant inductor and a magnetizing inductance of the primary winding coupled in series. The resonant tank circuit is coupled between the first switching node and the second switching node. The resonant capacitor has a first end and a second end. The first end of the resonant capacitor is coupled to the first end of the first sampling winding, the second end of the resonant capacitor is coupled to the first switching node, and the second end of the first sampling winding is configured to provide a first capacitor voltage sampling signal. The rectifier circuit is coupled between the first end of the secondary winding and the second end of the secondary winding. And the current sensing circuit is configured to receive the first capacitor voltage sampling signal and provide a current sensing signal based on the first capacitor voltage sampling signal. A portion of the current sensing signal greater than a threshold characterizes a current flowing through the resonant tank circuit.

Another embodiment of the present invention discloses a resonant converter. The resonant converter comprises a first transistor, a transformer, a resonant tank circuit, a rectifier circuit and a current sensing circuit. Each of the first, second, third and fourth transistors have a first end and a second end. The first end of the first transistor and the first end of the third transistor are coupled to a DC input voltage, the second end of the first transistor is coupled to the first end of the second transistor to form a first switching node, and the second end of the third transistor is coupled to the first end of the fourth transistor to form a second switching node. The transformer comprises a first primary winding, a second primary winding, and a secondary winding. Each of the first primary winding, the second primary winding and the secondary winding has a first end and a second end, the first end of the secondary winding is coupled to the second end of the second transistor, and the second end of the secondary winding is coupled to the second end of the fourth transistor. The resonant tank circuit comprises a resonant capacitor, a magnetizing inductance of the first primary winding, a magnetizing inductance of the second primary winding, a first resonant inductor, and a second resonant inductor. The resonant capacitor has a first end and a second end, the first resonant inductor and the first primary winding are coupled in series between the first switching node and the first end of the resonant capacitor, and the second resonant inductor and the second primary winding are coupled in series between the second switching node and the second end of the resonant capacitor. The rectifier circuit is coupled between the first end of the secondary winding and the second end of the secondary winding. The current sensing circuit is configured to receive a voltage at the first end of the resonant capacitor, perform high pass filtering on the voltage at the first end of the resonant capacitor to provide a high pass filtered signal. The current sensing circuit is further configured to provide a first current sensing signal via limiting a negative voltage of the high pass filtered signal to be not less than a first threshold. The portion of the first current sensing signal greater than the first threshold characterizes a current flowing through the resonant tank circuit.

Yet another embodiment of the present invention discloses a resonant converter. Each of the first, second, third and fourth transistors have a first end and a second end. The first end of the first transistor and the first end of the third transistor are coupled to a DC input voltage. The second end of the first transistor is coupled to the first end of the second transistor to form a first switching node. The second end of the third transistor is coupled to the first end of the fourth transistor to form a second switching node. The transformer comprises a first primary winding, a second primary winding, and a secondary winding. Each of the primary winding, the second primary winding, and the secondary winding has a first end and a second end. The first end of the secondary winding is coupled to the second end of the second transistor, and the second end of the secondary winding is coupled to the second end of the fourth transistor. The resonant tank circuit comprises a resonant inductor, a resonant capacitor and a magnetizing inductance of the first primary winding coupled in series. The resonant tank circuit is coupled between the first switching node and the second switching node. The resonant capacitor has a first end and a second end, wherein the first end of the resonant capacitor is coupled to the first primary winding. The rectifier circuit is coupled between the first end of the secondary winding and the second end of the secondary winding. And the current sensing circuit is configured to provide a current sensing signal based on a voltage at the first end of the resonant capacitor. The current sensing signal characterizes a current flowing through the resonant tank circuit. A portion of the current sensing signal greater than a threshold indicates a magnitude of a current flowing through the resonant tank circuit.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1 shows a schematic diagram of a resonant converter 100 in accordance with an embodiment of the present invention.

FIG. 2A shows a schematic diagram of a current sensing circuit 140A in accordance with an embodiment of the present invention.

FIG. 2B shows a schematic diagram of a current sensing circuit 140B in accordance with an embodiment of the present invention.

FIG. 2C shows a schematic diagram of a current sensing circuit 140C in accordance with an embodiment of the present invention.

FIG. 3 shows a waveform diagram 200 of the resonant converter 100 shown in FIG. 1 in accordance with an embodiment of the present invention.

FIG. 4 shows a schematic diagram of a resonant converter 300 in accordance with an embodiment of the present invention.

FIG. 5 shows a waveform diagram 400 of the resonant converter 300 shown in FIG. 4 in accordance with an embodiment of the present invention.

FIG. 6A shows a schematic diagram of a resonant converter 500A in accordance with an embodiment of the present invention.

FIG. 6B shows a schematic diagram of a resonant converter 500B in accordance with an embodiment of the present invention.

FIG. 7 shows a schematic diagram of a resonant converter 600 in accordance with an embodiment of the present invention.

FIG. 8 shows a schematic diagram of a resonant converter 700 in accordance with an embodiment of the present invention.

FIG. 9A shows a schematic diagram of a current sensing circuit 160A in accordance with an embodiment of the present invention.

FIG. 9B shows a schematic diagram of a current sensing circuit 160B in accordance with an embodiment of the present invention.

FIG. 9C shows a schematic diagram of a current sensing circuit 1600 in accordance with an embodiment of the present invention.

FIG. 10 shows a waveform diagram 800 of the resonant converter 700 shown in FIG. 9 in accordance with an embodiment of the present invention.

FIG. 11 shows a schematic diagram of a resonant converter 900 in accordance with an embodiment of the present invention.

FIG. 12 shows a current sensing method 1000 used for a resonant converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element. When a signal is described as “equal to” another signal, it is substantially identical to the other signal.

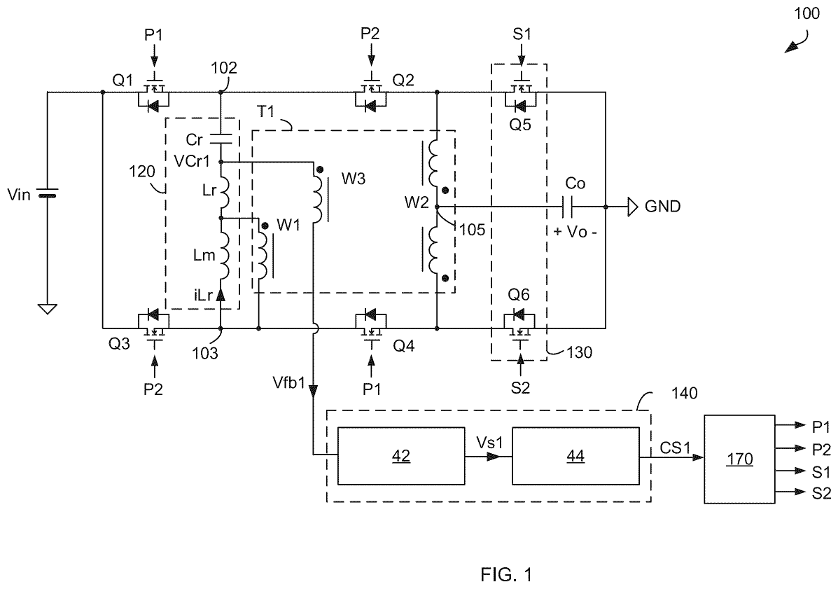

FIG. 1 shows a schematic diagram of a resonant converter 100 in accordance with an embodiment of the present invention. In the embodiment shown in FIG. 1, the resonant converter 100 includes transistors Q1-Q4, a resonant tank circuit 120, a transformer T1, a rectifier circuit 130, and a current sensing circuit 140.

In the embodiment shown in FIG. 1, the transistors Q1-Q4 constitute a switching full-bridge circuit, the transistors Q1 and Q2 constitute a first switching bridge branch and the transistors Q3 and Q4 constitute a second switching bridge branch. A first end of the transistor Q1 and a first end of the transistor Q3 are coupled to a DC input voltage Vin, a second end of the transistor Q1 is connected to a first end of the transistor Q2 to form a switching node 102, and a second end of the transistor Q3 is connected to a first end of the transistor Q4 to form a switching node 103. The switching full-bridge circuit consisting of transistors Q1-Q4 receives the DC input voltage Vin and converts the DC input voltage Vin into a pulse signal (e.g. a square wave signal). The resonant tank circuit 120 is coupled between the switching node 102 and the switching node 103 to receive the pulse signal and generates a resonant current iLr that flows through the resonant tank circuit 120. In the embodiment shown in FIG. 1, a direction of an arrow in the resonant tank circuit 120 is specified as a positive direction of the resonant current iLr, namely, when a direction of the resonant current iLr is as the direction indicated by the arrow, the resonant current iLr is denoted as a positive value, when the direction of the resonant current iLr is opposite to the direction indicated by the arrow, the resonant current iLr is denoted as a negative value.

A primary side of the transformer T1 has a primary winding W1 and a sampling winding W3, i.e. the sampling winding W3 is the other primary winding of the transformer T1. A secondary side of the transformer T1 has a secondary winding W2. In one example, a turns ratio of the primary winding W1 and the sampling winding W3 is 2:1. The primary winding W1, the sampling winding W3, and the secondary winding W2 are wound to have a polarity in accordance with the dot as shown in FIG. 1. The primary winding W1 has a magnetizing inductance Lm. In the embodiment shown in FIG. 1, the resonant converter 100 is a non-isolated resonant converter, a first end of the secondary winding W2 is coupled to a second end of the transistor Q2, and a second end of the secondary winding W2 is coupled to a second end of the transistor Q4. A center-tap of the secondary winding W2 divides the secondary winding W2 into two portions.

In the embodiment shown in FIG. 1, the resonant tank circuit 120 includes a resonant capacitor Cr, a resonant inductor Lr, and the magnetizing inductance Lm of the primary winding W1. The resonant capacitor Cr, the resonance inductor Lr, and the magnetizing inductance Lm of the primary winding W1 constitute a series circuit, in order to form the resonant tank. In the embodiment shown in FIG. 1, a first end of the resonant capacitor Cr is connected to a first end of the resonant inductor Lr, and a second end of the resonant capacitor Cr is connected to the switching node 102. A second end of the resonant inductor Lr is connected to a first end of the primary winding W1, a second end of the primary winding W1 is connected to the switching node 103. In some embodiments of the present invention, the resonant inductor Lr may be a leakage inductance of the primary winding W1.

The rectifier circuit 130 rectifies a current induced from the secondary winding W2 of the transformer T1, and the rectified signal is filtered via an output capacitor Co to obtain a DC output voltage Vo of the resonant converter 100.

In one embodiment, the rectifier circuit 130 includes transistors Q5 and Q6. A first end of the transistor Q5 is coupled to the first end of the secondary winding W2, a first end of the transistor Q6 is coupled to the second end of the secondary winding W2, and a second end of each transistor Q5 and transistor Q6 is coupled to a reference ground GND. The center-tap of the secondary winding W2 serves as an output voltage node 105 to provide the DC output voltage Vo of the resonant converter 100, and the output capacitor Co is coupled between the output voltage node 105 and the reference ground GND.

In the embodiments of the present invention, each of the transistors Q1-Q6 may comprise a metal oxide semiconductor field effect transistor (MOSFET) or other type of transistor. Each of the transistors Q1-Q6 may have the first end (e.g. a drain), the second end (e.g. a source) and a control end (e.g. a gate), and a connection state between the first end and the second end may be controlled by a signal at the control end, e.g., the signal at the control end is used to turn-on and turn-off the corresponding transistor. In the embodiment shown in FIG. 1, the transistors Q1-Q6 are all MOSFETs.

In one embodiment, the resonant converter 100 further includes a controller 170. The controller 170 provides control signals P1, P2 to the switching full-bridge circuit consisting of the transistors Q1-Q4, so as to control the turn-on and turn-off of the transistors Q1-Q4. The transistors Q1 and Q4 are turned on and turned off synchronously, and the transistors Q2 and Q3 are turned on and turned off synchronously. For example, the control signal P1 is used to control the transistors Q1, Q4, and the control signal P2 is used to control the transistors Q2, Q3. In the embodiment shown in FIG. 1, the controller 170 further provides control signals S1, S2 to the rectifier circuit 130. The control signal S1 is used to control the turn-on and turn-off of the transistor Q5, and the control signal S2 is used to control the turn-on and turn-off of the transistor Q6. The control signals P1, P2, S1, S2 may be, for example, pulse width modulation (PWM) signals.

In the embodiment shown in FIG. 1, the sampling winding W3 is used for sampling a voltage at the first end of the resonant capacitor Cr, a first end of the sampling winding W3 is connected to the first end of the resonant capacitor Cr to receive a voltage VCr1 at the first end of the resonant capacitor Cr, a second end of the sampling winding W3 provides a capacitor voltage sampling signal Vfb1. The capacitor voltage sampling signal Vfb1 is a signal with an alternating current (AC) component superimposed by a DC bias.

The current sensing circuit 140 includes a high pass filtering circuit 42 and a negative clamping circuit 44. The high pass filtering circuit 42 receives the capacitor voltage sampling signal Vfb1, and filters out DC component of the capacitor voltage sampling signal Vfb1 to generate an AC sampling signal Vs1. The negative clamping circuit 44 receives the AC sampling signal Vs1 and limits a negative voltage portion of the AC sampling signal Vs1 to be not less than a threshold Vth, so as to provide a current sensing signal CS1 to the controller 170. In one example, the threshold Vth is close to or equal to zero voltage. In each cycle, the current sensing signal CS1 is equal to the threshold Vth for a time period close to or equal to half of the cycle. The current sensing signal CS1 varies for the remaining time period of the cycle and has a value greater than the threshold Vth. The threshold Vth could be fixed and does not change when a peak value of the resonant current iLr changes. The current sensing signal CS1 is used to represent the resonant current iLr flowing through the resonant tank circuit 120 when the current sensing signal CS1 is greater than the threshold Vth. In one embodiment, the current sensing signal CS1 is provided to the controller 170, the controller 170 senses the resonant current iLr based on the current sensing signal CS1 and further performs functions of current reporting, over-current protecting, etc.

The resonant converter of the embodiments of the present invention implements resonant current sensing using the voltage at one end of the resonant capacitor. For a conventional full-bridge resonant converter, a voltage signal at either end of the resonant capacitor has a DC bias that transits with a switching period. However, in the embodiment of the present invention, the capacitor voltage sampling signal Vfb1 sampled by the sampling winding W3 no longer has a switched DC bias, but is a signal with a component approximate to a sinusoidal wave superimposed by a certain DC bias. Such a capacitor voltage sampling signal Vfb1 is processed by the current sensing circuit 140 to obtain the current sensing signal CS1 used for characterizing the resonant current iLr. Compared with the conventional art, the present invention does not require series connection of an additional sensing device in the resonant tank circuit, thereby reducing power loss and cost caused by resonant current sensing.

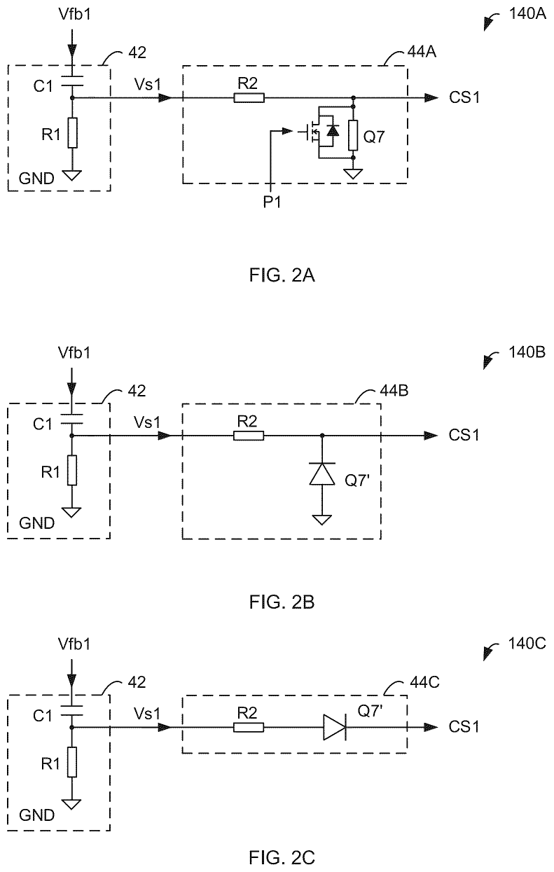

FIG. 2A shows a schematic diagram of a current sensing circuit 140A in accordance with an embodiment of the present invention. The current sensing circuit 140A includes the high pass filtering circuit 42 and a negative clamping circuit 44A. In the embodiment shown in FIG. 2A, the high pass filtering circuit 42 includes a filter capacitor C1 and a filter resistor R1 coupled in series. A first end of the filter capacitor C1 receives the capacitor voltage sampling signal Vfb1, a second end of the filter capacitor C1 is coupled to a first end of the filter resistor R1, and a second end of the filter resistor R1 is coupled to the reference ground GND. The high pass filtering circuit 42 performs high pass filtering on the received capacitor voltage sampling signal Vfb1 and provides an AC sampling signal Vs1 at an output end of the high pass filtering circuit 42. The negative clamping circuit 44A includes a sensing transistor Q7, the sensing transistor Q7 includes a first end and a second end. The first end of the sensing transistor Q7 is coupled to the output end of the high pass filtering circuit 42 and the second end of the sensing transistor Q7 is coupled to the reference ground GND. In one embodiment, the first end of the sensing transistor Q7 is coupled to the output end of the high pass filtering circuit 42 through a matching resistor R2. The negative clamping circuit 44A provides the current sensing signal CS1 at the first end of the sensing transistor Q7. In one embodiment, the matching resistor R2 may be a discrete resistor, or may represent a parasitic resistor.

In the embodiment shown in FIG. 2A, the sensing transistor Q7 is a MOSFET having the first end, the second end, and a control end. The sensing transistor Q7 is turned off when the AC sampling signal Vs1 is greater than zero, and turned on when the AC sampling signal Vs1 is less than zero, so as to limit the negative voltage portion of the AC sampling signal Vs1 to not be less than the threshold Vth, and obtain the current sensing signal CS1. The threshold Vth is for example close to or equal to zero voltage.

In some embodiments, turn-on and turn-off of the sensing transistor Q7 may be controlled (e.g., using the control signal P1 or P2 generated by the controller 170) based on switching state of the transistors Q1-Q4 in the switching full-bridge circuit. In the embodiment shown in FIG. 2A, by setting the capacitance of the filter capacitor C1 and the resistance of the filter resistor R1 in the high pass filtering circuit 42, the AC sampling signal Vs1 is regulated to be in phase or be substantially in phase with the resonant current iLr, for example the phase difference between the AC sampling signal Vs1 and the resonant current iLr is within 20 deg. Then, turn-on and turn-off timing of the sensing transistor Q7 is the same as or substantially the same as turn-on and turn-off timing of the transistors Q1 and Q4. Therefore, the turn-on and turn-off of the sensing transistor Q7 can be controlled via the control end of the sensing transistor Q7 based on the switching state of the transistors Q1 and Q4, for example, turning on the sensing transistor Q7 when the transistors Q1 and Q4 are turned on, and turning off the sensing transistor Q7 when the transistors Q1 and Q4 are turned off. In another embodiment, it is also possible to control the turn-on and turn-off of the sensing transistor Q7 in the negative clamping circuit 44A via the control end of the sensing transistor Q7 based on switching state of the transistor Q5, for example, turning on the sensing transistor Q7 when the transistor Q5 is turned on, and turning off the sensing transistor Q7 when the transistor Q5 is turned off. In other embodiments of the present invention, the resonant tank circuit can be connected in other specific ways (e.g. by connecting the second end of the resonant capacitor Cr to the switching node 103), and the sensing transistor Q7 could be turned on and turned off via the control end of the sensing transistor Q7 based on the switching state of the transistor Q2, Q3 or the switching state of the transistor Q6.

FIG. 2B shows a schematic diagram of a current sensing circuit 140B in accordance with an embodiment of the present invention. The current sensing circuit 140B includes the high pass filtering circuit 42 and a negative clamping circuit 44B. The negative clamping circuit 44B includes a sensing transistor Q7′. The sensing transistor Q7′ is a diode, a cathode of the sensing transistor Q7′ is coupled to the output end of the high pass filtering circuit 42 and provides the current sensing signal CS1, and an anode of the sensing transistor Q7′ is coupled to the reference ground, so that the negative voltage portion of the current sensing signal CS1 is limited to be not less than the threshold Vth, the threshold Vth is close to zero voltage, for example,-0.7V. In one embodiment, the anode of the sensing transistor Q7′ is coupled to the output end of the high pass filtering circuit 42 through the matching resistor R2.

FIG. 2C shows a schematic diagram of a current sensing circuit 140C in accordance with an embodiment of the present invention. The current sensing circuit 140C includes the high pass filtering circuit 42 and a negative clamping circuit 44C. The negative clamping circuit 44C includes the sensing transistor Q7′. The sensing transistor Q7′ is a diode, the anode of the sensing transistor Q7′ is coupled to the output end of the high pass filtering circuit 42 and the cathode of the sensing transistor Q7′ outputs the current sensing signal CS1. The negative portion of the current sensing signal CS1 is limited to be not less than the threshold Vth, for example, close to or equal to zero voltage.

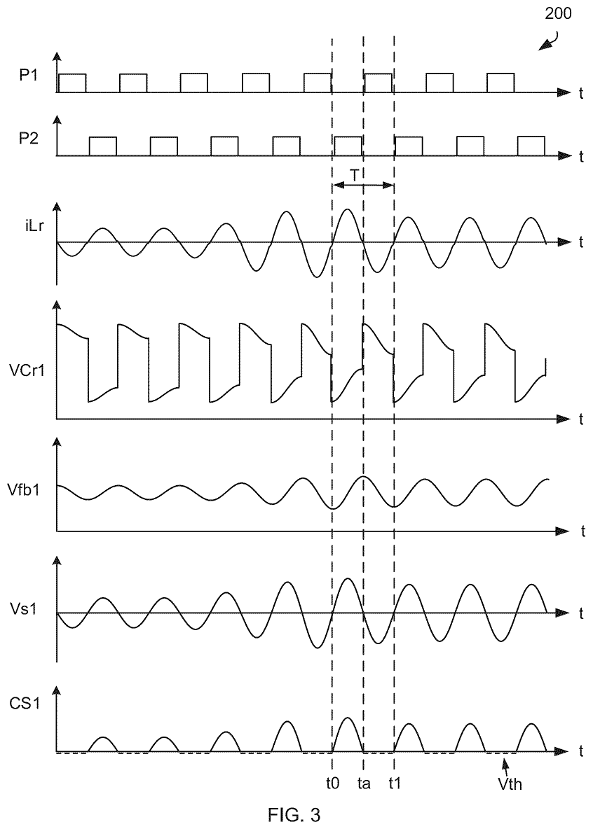

FIG. 3 shows a waveform diagram 200 of the resonant converter 100 shown in FIG. 1 in accordance with an embodiment of the present invention. FIG. 3 shows waveforms of the control signal P1, the control signal P2, the resonant current iLr, the voltage VCr1 at the first end of the resonant capacitor Cr, the capacitor voltage sampling signal Vfb1, the AC sampling signal Vs1, and the current sensing signal CS1. In the waveform diagram 200, a horizontal axis represents time, and a time period t0-t1 is one switching period T of the resonant converter 100. In the embodiment shown in FIG. 3, the control signal P1 controls the turn-on and turn-off of the transistors Q1, Q4 and the control signal P2 controls the turn-on and turn-off of the transistors Q2, Q3 and Q7. As shown in FIG. 3, a waveform of the resonant current iLr is approximate to a sinusoidal wave, and the direction of the arrow in the resonant tank circuit 120 in FIG. 1 is specified as the positive direction of the resonant current iLr, namely, when the direction of the resonant current iLr is as the direction indicated by the arrow in FIG. 1, the waveform of the resonant current iLr in the waveform diagram 200 is positive, and when the direction of the resonant current iLr is opposite to the direction indicated by the arrow in FIG. 1, the waveform of the resonant current iLr in the waveform diagram 200 is negative. In the embodiment shown in FIG. 3, the sampling winding W3 converts the voltage VCr1 at the first end of the resonant capacitor Cr to the capacitor voltage sampling signal Vfb1 having a certain DC component, a phase of the capacitor voltage sampling signal Vfb1 is lagged 90 deg. behind the phase of the resonant current iLr.

In the embodiment shown in FIG. 3, the high pass filtering circuit 42 filters out the DC component of the capacitor voltage sampling signal Vfb1 to obtain the AC sampling signal Vs1, and regulates a phase of the AC sampling signal Vs1 to coincide with the phase of the resonant current iLr. So that the switching period T represents one cycle of the current sensing signal CS1 as well. In other embodiments of the present invention, the high pass filtering circuit 42 regulates the phase of the AC sampling signal Vs1 to be substantially in phase with the resonant current iLr. The negative clamping circuit 44 converts the AC sampling signal Vs1 to the current sensing signal CS1. As shown in FIG. 3, during the time period t0-ta, the current sensing signal CS1 characterizes the value of the resonant current iLr in a first half of the switching period T, during a time period ta-t1, the current sensing signal CS1 is equal to the threshold Vth (as indicated by a dashed line in a waveform of the current sensing signal CS1).

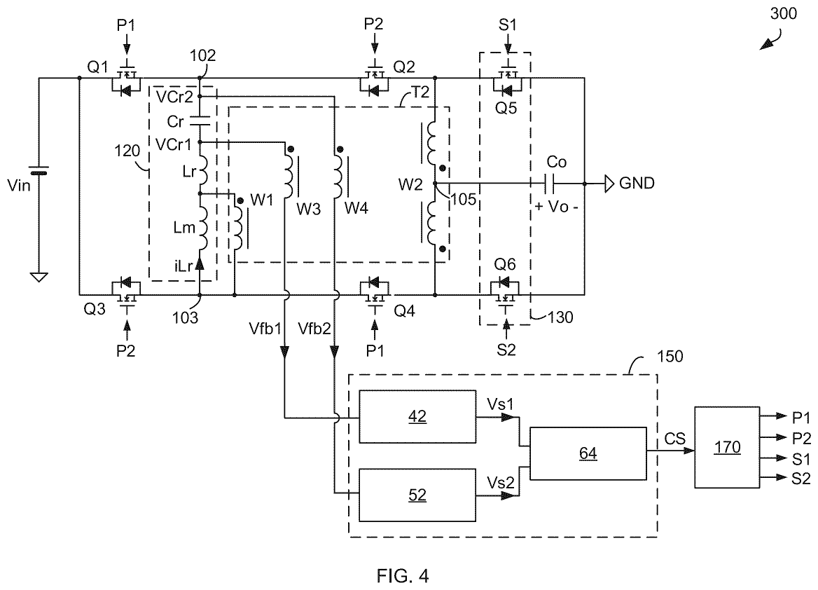

FIG. 4 shows a schematic diagram of a resonant converter 300 in accordance with an embodiment of the present invention. The resonant converter 300 includes the transistors Q1-Q4, the resonant tank circuit 120, a transformer T2, the rectifier circuit 130 and a current sensing circuit 150. The transistors Q1-Q4, the resonant tank circuit 120 and the rectifier circuit 130 shown in FIG. 4 are connected and operate in the same manner with the resonant converter 100. Compared to the transformer T1, a primary side of the transformer T2 further includes a sampling winding W4. In one example, a turns ratio of the primary winding W1, the sampling winding W3 and the sampling winding W4 is 2:1:1. In the embodiment shown in FIG. 4, a first end of the sampling winding W4 is connected to the second end of the resonant capacitor Cr (i.e., the switching node 102) to receive a voltage VCr2 at the second end of the resonant capacitor Cr, and a second end of the current sensing winding W4 provides a capacitor voltage sampling signal Vfb2. The capacitor voltage sampling signal Vfb2 is a DC signal having a small ripple. The current sensing circuit 150 includes the high pass filtering circuit 42, a high pass filtering circuit 52, and a negative clamping circuit 64. The current sensing circuit 150 receives the capacitor voltage sampling signal Vfb1 and the capacitor voltage sampling signal Vfb2. The high pass filtering circuit 42 performs high pass filtering on the capacitor voltage sampling signal Vfb1 to obtain the AC sampling signal Vs1, the high pass filtering circuit 52 performs high pass filtering on the capacitor voltage sampling signal Vfb2 to obtain an AC sampling signal Vs2. The negative clamping circuit 64 receives the AC sampling signals Vs1 and Vs2 and limits the negative voltage portion of the differential signal of the AC sampling signals Vs1 and Vs2 to be not less than the threshold Vth so as to provide a current sensing signal CS to the controller 170. The portion of the current sensing signal CS greater than the threshold Vth characterizes the resonant current iLr flowing through the resonant tank circuit 120.

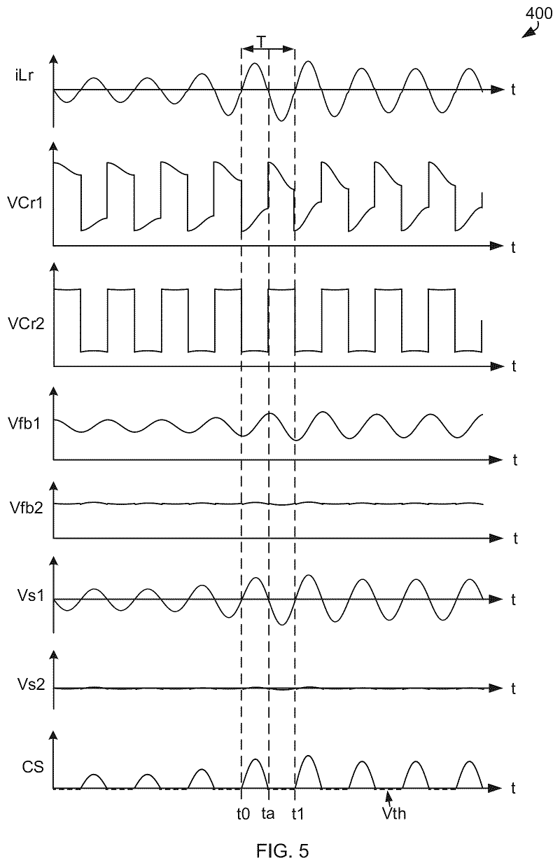

FIG. 5 shows a waveform diagram 400 of the resonant converter 300 shown in FIG. 4 in accordance with an embodiment of the present invention. FIG. 5 shows waveforms of the resonant current iLr, the voltage VCr1 at the first end of the resonant capacitor Cr, the voltage VCr2 at the second end of the resonant capacitor Cr, the capacitor voltage sampling signal Vfb1, the capacitor voltage sampling signal Vfb2, the AC sampling signal Vs1, the AC sampling signal Vs2, and the current sensing signal CS. The waveforms of the voltage VCr1 and the capacitor voltage sampling signal Vfb1 are identical to those described in the waveform diagram 200. In the waveform diagram 400, the horizontal axis represents time, and the time period t0-t1 is one switching period T of the resonant converter 300. A direction of an arrow in the resonant tank circuit 120 of FIG. 4 is specified as the positive direction of the resonant current iLr. As shown in FIG. 5, the voltage VCr2 is an approximate square wave, the sampling winding W4 converts the voltage VCr2 to a DC signal having a small ripple, namely, the capacitor voltage sampling signal Vfb2. Both the capacitor voltage sampling signal Vfb2 and the capacitor voltage sampling signal Vfb1 have equal DC component. The high pass filtering circuit 52 further filters out the DC component of the capacitor voltage sampling signal Vfb2 to obtain the AC sampling signal Vs2. In the embodiment shown in FIG. 5, the negative clamping circuit 64 converts the differential signal of the AC sampling signals Vs1 and Vs2 into the current sensing signal CS, and the AC sampling signals Vs1 and Vs2 are respectively provided by the high-pass filtering circuits 42 and 52. During the time period t0-ta, a value of the current sensing signal CS varies linearly with a value of the resonant current iLr, and therefore the current sensing signal CS characterizes the value of the resonant current iLr in the first half of the switching period T. During the time period ta-t1, the current sensing signal CS is equal to the threshold Vth (as indicated by the dashed line in a waveform of the current sensing signal CS).

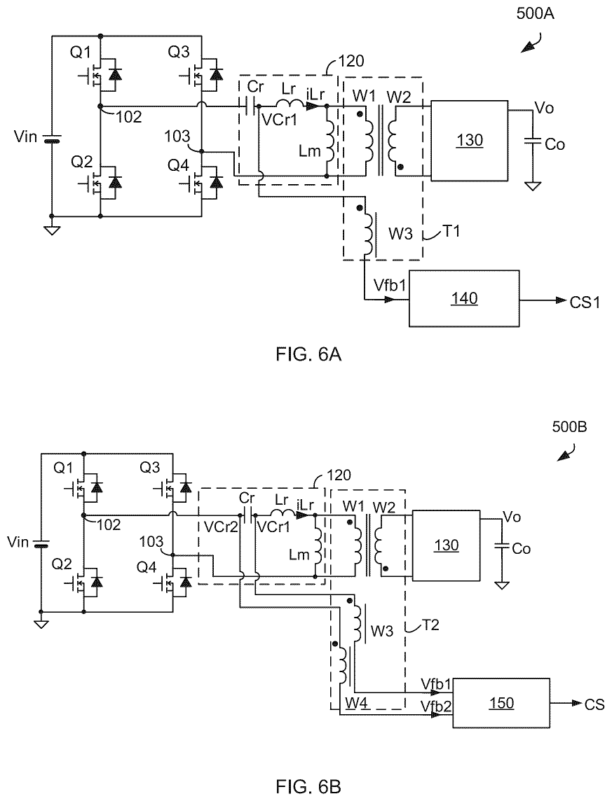

FIG. 6A shows a schematic diagram of a resonant converter 500A in accordance with an embodiment of the present invention. The resonant converter 500A includes the transistors Q1 to Q4, the resonant tank circuit 120, the transformer T1, the rectifier circuit 130, and the current sensing circuit 140. And the components described above are connected and operate in the same manner with the resonant converter 100 except that the primary side and the secondary side of the transformer T1 in resonant converter 500A are electrically isolated. The rectifier circuit 130 may include, for example, a rectifier topology such as a full bridge rectifier circuit, a current doubler rectifier circuit, and the like.

FIG. 6B shows a schematic diagram of a resonant converter 500B in accordance with an embodiment of the present invention. The resonant converter 500B includes the transistors Q1 to Q4, the resonant tank circuit 120, the transformer T2, the rectifier circuit 130, and the current sensing circuit 140. The components described above are connected and operate in the same manner with the resonant converter 300 except that the primary side and the secondary side of the transformer T2 in resonant converter 500B are electrically isolated. The rectifier circuit 130 may include, for example, a rectifier topology such as a full bridge rectifier circuit, a current doubler rectifier circuit, and the like.

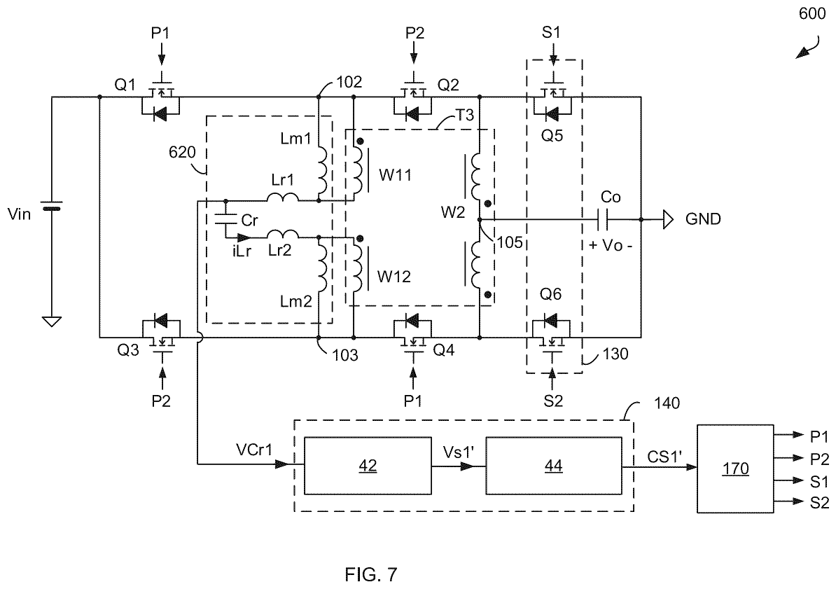

FIG. 7 shows a schematic diagram of a resonant converter 600 in accordance with an embodiment of the present invention. In the embodiment shown in FIG. 7, the resonant converter 600 includes the transistors Q1-Q4, a resonant tank circuit 620, a transformer T3, the rectifier circuit 130 and the current sensing circuit 140. And the transistors Q1-Q4 and the rectifier circuit 130 shown in FIG. 7 are connected and operate in the same manner with the resonant converter 600.

In the embodiment shown in FIG. 7, the resonant tank circuit 620 is coupled between the switching node 102 and the switching node 103. A primary side of the transformer T3 has primary windings W11, W12, and a secondary side of the transformer T3 has the secondary winding W2. The primary winding W11 has a magnetizing inductance Lm1, and the primary winding W12 has a magnetizing inductance Lm2. In the embodiment shown in FIG. 7, the resonant converter 600 is a non-isolated resonant converter with the first end of the secondary winding W2 coupled to the second end of the transistor Q2 and the second end of the secondary winding W2 coupled to the second end of the transistor Q4.

In the embodiment shown in FIG. 7, the resonant tank circuit 620 includes the resonant capacitor Cr, a resonant inductor Lr1, a resonant inductor Lr2, the magnetizing inductance Lm1 of the primary winding W11, and the magnetizing inductance Lm2 of the primary winding W12 coupled in series. In the embodiment shown in FIG. 7, the first end of the primary winding W11 is connected to the switching node 102, a second end of the primary winding W11 is connected to a first end of the resonant inductor Lr1, a second end of the resonant inductor Lr1 is connected to the first end of the resonant capacitor Cr, the second end of the resonant capacitor Cr is connected to a first end of the resonant inductor Lr2, a second end of the resonant inductor Lr2 is connected to a first end of the primary winding W12, and a second end of the primary winding W12 is connected to the switching node 103. In some embodiments of the present invention, the resonant inductor Lr1 may be a leakage inductance of the primary winding W11, and the resonant inductor Lr2 may be a leakage inductance of the primary winding W12. In one embodiment, the primary windings W11 and W12 have an equal number of turns, so the voltage VCr1 at the first end of the resonant capacitor Cr is a signal with an AC component superimposed by a DC bias, and the voltage VCr2 at the second end of the resonant capacitor Cr is a signal with an AC component superimposed by a DC bias. The voltage VCr1 and the voltage VCr2 have equal DC bias. A cycle of the voltage VCr1 and the voltage VCr2 are identical and both of them are equal to the switching period of the resonant converter 600. A direction of an arrow in the resonant tank circuit 620 of FIG. 7 is specified as the positive direction of the resonant current iLr.

In the embodiment shown in FIG. 7, the current sensing circuit 140 directly samples the voltage VCr1 at the first end of the resonant capacitor Cr, and the high pass filtering circuit 42 in the current sensing circuit 140 filters out DC component of the voltage VCr1 to obtain an AC sampling signal Vs1′. In one embodiment, the high pass filtering circuit 42 further regulates the AC sampling signal Vs1′ to be in phase or be substantially in phase with the resonant current iLr. The negative clamping circuit 44 limits a negative voltage portion of the AC sampling signal Vs1′ to be not less than a threshold Vth1 so as to provide a current sensing signal CS1′ to the controller 170, and the threshold Vth1 is close to or equal to zero voltage. The current sensing signal CS1′ is used to represent the resonant current iLr flowing through the resonant tank circuit 620 when the current sensing signal CS1′ is greater than the threshold Vth1. The current sensing circuit 140 may include, for example, a specific circuit structure shown in one of FIG. 2A to FIG. 2C.

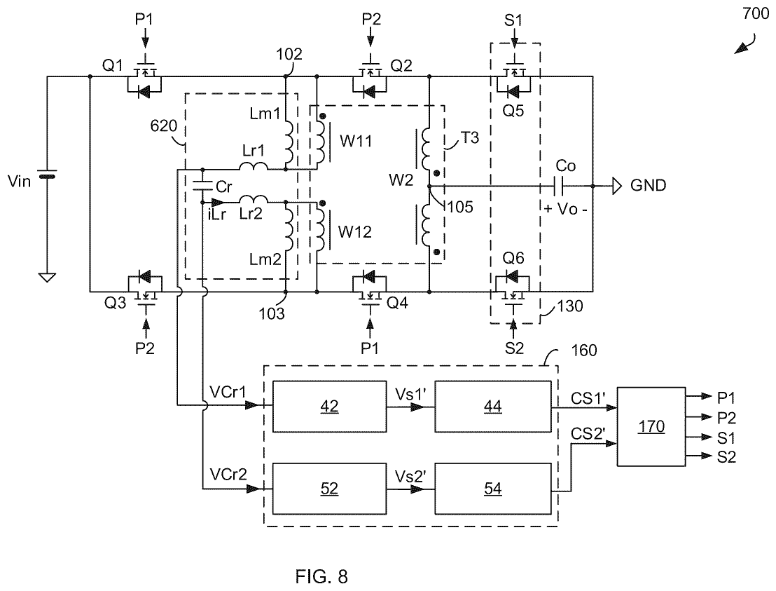

FIG. 8 shows a schematic diagram of a resonant converter 700 in accordance with an embodiment of the present invention. The resonant converter 700 includes the transistors Q1-Q4, the resonant tank circuit 620, the transformer T3, the rectifier circuit 130 and a current sensing circuit 160, and the transistors Q1-Q4, the resonant tank circuit 620, the transformer T3 and the rectifier circuit 130 shown in FIG. 8 are connected and operate in the same manner with the resonant converter 600. Compared with the current sensing circuit 140 in the resonant converter 600, the current sensing circuit 160 further includes a high pass filtering circuit 52 and a negative clamping circuit 54. The high pass filtering circuit 52 receives the voltage VCr2 at the second end of the resonant capacitor Cr, and filters out a DC component of the voltage VCr2 to obtain an AC sampling signal Vs2′. The negative clamping circuit 54 limits a negative voltage portion of the AC sampling signal Vs2′ to be not less than a threshold Vth2 so as to provide a current sensing signal CS2′. In one embodiment, the threshold Vth2 is close to or equal to zero voltage. A portion of the current sensing signal CS2′ greater than the threshold Vth2 is used to represent the resonant current iLr flowing through the resonant tank circuit 620.

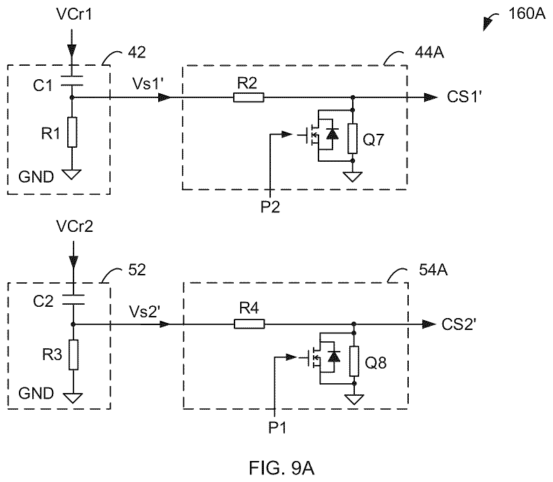

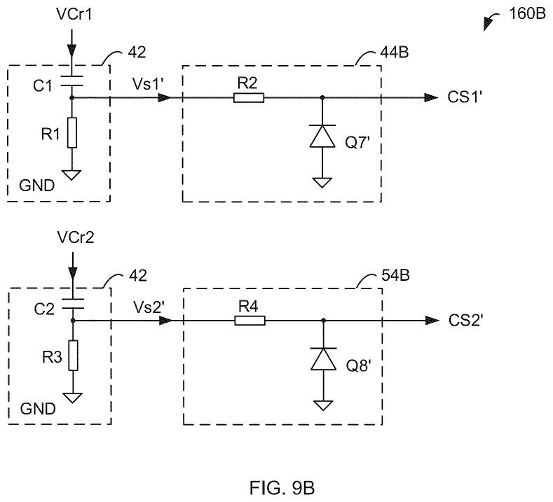

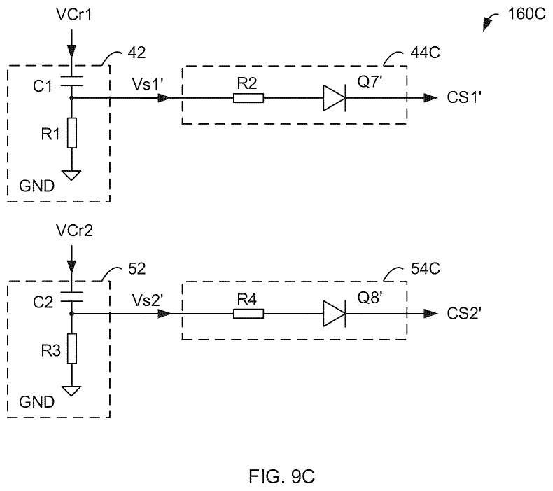

FIG. 9A shows a schematic diagram of a current sensing circuit 160A in accordance with an embodiment of the present invention. In the embodiment shown in FIG. 9A, the circuit structures of the high pass filtering circuit 42 and the negative clamping circuit 44A are identical to those described at the current sensing circuit 140A shown in FIG. 2A. Similar to the high pass filtering circuit 42, the high pass filtering circuit 52 includes a filter capacitor C2 and a filter resistor R3 coupled in series. A first end of the filter capacitor C2 receives the voltage VCr2 at the second end of the resonant capacitor Cr, the filter resistor R3 is coupled to the reference ground GND. A negative clamping circuit 54A includes a sensing transistor Q8 that includes a first end and a second end. The first end of the sensing transistor Q8 is coupled to an output end of the high pass filtering circuit 52 and the second end of the sensing transistor Q8 is coupled to the reference ground GND. In one embodiment, the first end of sensing transistor Q8 is coupled to the output end of the high pass filtering circuit 52 through a matching resistor R4. The negative clamping circuit 54A provides the current sensing signal CS2′ at the first end of sensing transistor Q8. In one embodiment, the matching resistor R4 may be, for example, a discrete resistor, or may represent a parasitic resistor.

In current sensing circuit 160A, the sensing transistors Q7 and Q8 are MOSFETs, having the first end, the second end, and a control end. The sensing transistor Q7 is turned off when the AC sampling signal Vs1 is greater than zero, and turned on when the AC sampling signal Vs1 is less than zero. The sensing transistor Q8 is turned off when the AC sampling signal Vs2 is greater than zero, and turned on when the AC sampling signal Vs2 is less than zero. In one embodiment, the phase of the AC sampling signal Vs1′ is regulated to be in phase or be substantially in phase with the resonant current, for example, the phase difference between the AC sampling signal Vs1′ and the resonant current iLr is within 20 deg. Then, a turn-on and turn-off timing of the sensing transistor Q7 is the same as or substantially the same as the turn-on and turn-off timing of the transistors Q2 and Q3. Therefore, the turn-on and turn-off of the sensing transistor Q7 can be controlled based on the switching state of the transistors Q2 and Q3. Similarly, in one embodiment, a turn-on and turn-off of the transistor Q8 may be controlled based on the switching state of the transistors Q1, Q4, for example, turning on the sensing transistor Q8 when the transistors Q1, Q4 are turned on, and turning off the sensing transistor Q8 when the transistors Q1, Q4 are turned off. In another embodiment of the present invention, the turn-on and turn-off of the sensing transistor Q8 in the negative clamping circuit 54A may also be controlled based on the switching state of the transistor Q5, for example, when the transistor Q5 is turned on, turning on the sensing transistor Q8, and when the transistor Q5 is turned off, turning off the sensing transistor Q8.

FIG. 9B shows a schematic diagram of a current sensing circuit 160B in accordance with an embodiment of the present invention. In the embodiment shown in FIG. 9B, the circuit structures of the high pass filtering circuit 42 and the negative clamping circuit 44B are identical to those described at the current sensing circuit 140B shown in FIG. 2B. The negative clamping circuit 54B includes a sensing transistor Q8′. The sensing transistor Q8′ is a diode, a cathode of the sensing transistor Q8′ is coupled to the output end of the high pass filtering circuit 52 and provides the current sensing signal CS2′, and an anode of the sensing transistor Q8′ is coupled to the reference ground. In one embodiment, the anode of the sensing transistor Q8′ is coupled to the output end of the high pass filtering circuit 52 through the matching resistor R4.

FIG. 9C shows a schematic diagram of a current sensing circuit 160C in accordance with an embodiment of the present invention. In the embodiment shown in FIG. 9C, the circuit structures of the high pass filtering circuit 42 and the negative clamping circuit 44C are identical to those described at the current sensing circuit 140C shown in FIG. 2C. A negative clamping circuit 54C includes the sensing transistor Q8′. The sensing transistor Q8′ is a diode, the anode of the sensing transistor Q8′ is coupled to the output end of the high pass filtering circuit 52 and the cathode of the sensing transistor Q8′ outputs the current sensing signal CS2′.

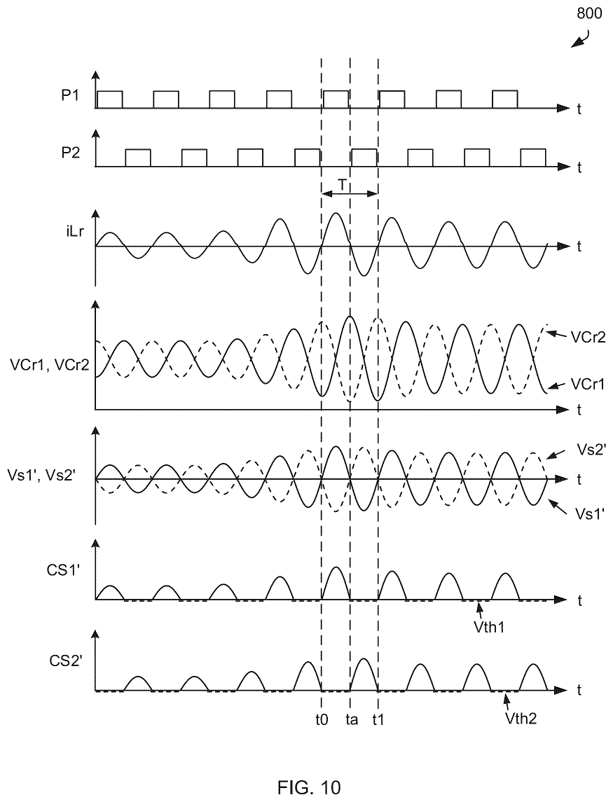

FIG. 10 shows a waveform diagram 800 of the resonant converter 700 shown in FIG. 9 in accordance with an embodiment of the present invention. FIG. 10 shows waveforms of the control signal P1, the control signal P2, the resonant current iLr, the voltage VCr1 at the first end of the resonant capacitor Cr, the voltage VCr2 at the second end of the resonant capacitor Cr, the AC sampling signal Vs1′, the AC sampling signal Vs2′, the current sensing signal CS1′ and the current sensing signal CS2′. In waveform diagram 800, the horizontal axis represents time, and the time period t0 to t1 is one switching period T of the resonant converter 700. In the embodiment shown in FIG. 10, the control signal P1 controls the turn-on and turn-off of the transistors Q1, Q4, and Q8, and the control signal P2 controls the turn-on and turn-off of the transistors Q2, Q3, and Q7. A direction of an arrow in the resonant tank circuit 620 of FIG. 8 is specified as the positive direction of the resonant current iLr. In a waveform diagram of the voltages VCr1, VCr2, the waveform of the voltage VCr1 is represented by a solid line, and the waveform of the voltage VCr2 is represented by a dashed line. As shown in FIG. 10, a phase of the voltage VCr1 is lagged 90 deg. behind the phase of the resonant current iLr.

In the embodiment shown in FIG. 10, the high pass filtering circuit 42 filters out the DC component of the voltage VCr1 to obtain the AC sampling signal Vs1′, and regulates the phase of the AC sampling signal Vs1′ to coincide with the phase of the resonant current iLr. The negative clamping circuit 44 converts the AC sampling signal Vs1′ to the current sensing signal CS1′. As shown in FIG. 10, the voltage VCr2 at the second end of the resonant capacitor Cr and the voltage VCr1 at the first end of the resonant capacitor Cr have equal DC component, and AC component of the voltage VCr1 and the voltage VCr2 are equal in magnitude and opposite in phase at any time period. In a waveform diagram of the AC sampling signals Vs1′, vs2′, the waveform of the AC sampling signal Vs1′ is represented by a solid line, and the waveform of the AC sampling signal Vs2′ is represented by a dashed line. The voltage VCr2 is filtered by the high pass filtering circuit 52 and becomes the AC sampling signal Vs2′ having a phase opposite to the phase of the AC sampling signal Vs1′. The negative clamping circuit 54 converts the AC sampling signal Vs2′ to the current sensing signal CS2′. In the embodiment shown in FIG. 10, during the time period t0-ta, the current sensing signal CS2′ is equal to the threshold Vth1 (as indicated by the dashed line in a waveform of the current sensing signal CS1′), and a value of the current sensing signal CS1′ varies linearly with a value of the resonant current iLr, and therefore the current sensing signal CS1′ characterizes the value of the resonant current iLr in the first half of the switching period T. During the time period ta-t1, the current sensing signal CS1′ is equal to the threshold Vth2 (as indicated by the dashed line in a waveform of the current sensing signal CS2′), a value of the current sensing signal CS2′ varies linearly with the value of the resonant current iLr, and therefore the current sensing signal CS2′ characterizes the value of the resonant current iLr in the second half of the switching period T. In one embodiment, the current sensing signals CS1′ and CS2′ are both provided to the controller 170 to improve speed and accuracy of the resonant current sensing. The controller 170 senses the resonant current iLr based on the current sensing signals CS1′ and CS2′ to perform the functions of current reporting, over-current protecting, etc.

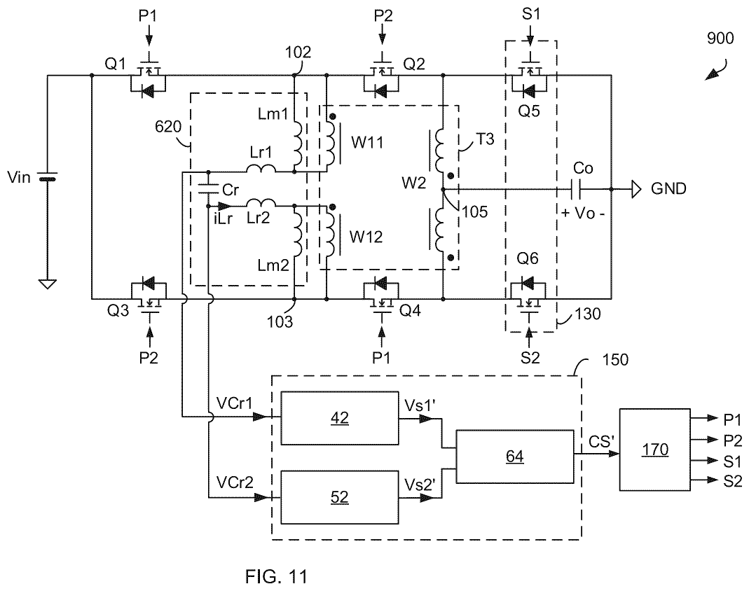

FIG. 11 shows a schematic diagram of a resonant converter 900 in accordance with an embodiment of the present invention. The resonant converter 900 comprises the transistors Q1-Q4, the resonant tank circuit 620, the transformer T3, the rectifier circuit 130 and the current sensing circuit 150, and the transistors Q1-Q4, the resonant tank circuit 120, the transformer T3 and the rectifier circuit 130 shown in FIG. 11 are connected and operate in the same manner with the resonant converter 700. The current sensing circuit 150 receives the voltage VCr1 at one end of the resonant capacitor Cr and the voltage Vcr2 at the other end of the resonant capacitor Cr. The high pass filtering circuit 42 converts the voltages VCr1 into the AC sampling signals Vs1′ and the high pass filtering circuit 52 converts the voltages VCr2 into AC sampling signals Vs2′. The negative clamping circuit 64 limits the negative voltage portion of the differential signal of the AC sampling signals Vs1′ and Vs2′ to be not less than a threshold, so as to provides a current sensing signal CS′. A portion of the current sensing signal CS' greater than the threshold characterizes the resonant current iLr flowing through the resonant tank circuit 620.

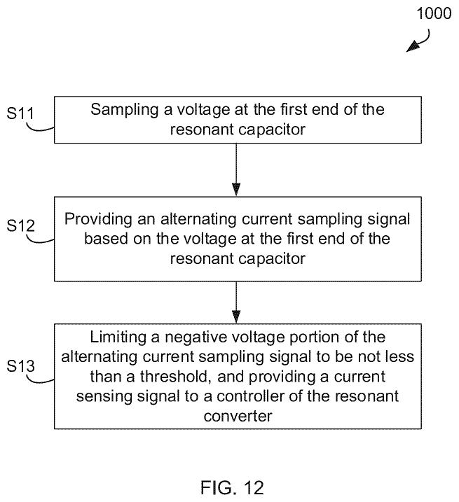

FIG. 12 shows a current sensing method 1000 used for a resonant converter in accordance with an embodiment of the present invention. The resonant converter receives a DC input voltage and provides a DC output voltage, and the resonant converter includes a switching full-bridge circuit, a transformer and a resonant tank circuit, and the switching full-bridge circuit has a first switching node and a second switching node, and a primary side of the transformer comprises at least a first primary winding and a second primary winding. The resonant tank circuit is coupled between the first switching node and the second switching node. The resonant tank circuit includes, for example, a resonant capacitor, a resonant inductor, and a magnetizing inductance of the first primary winding of the transformer coupled in series, and a first end of the resonant capacitor is coupled to the first primary winding. The resonant tank circuit may include the resonant capacitor, the resonant inductor, the magnetizing inductance of the first primary winding, and a magnetizing inductance of the second primary winding coupled in series as well. The current sensing method 1000 is used for sensing a current flowing through the resonant tank circuit of the resonant converter, the method including steps S11-S13.

In step S11, sampling a voltage at the first end of the resonant capacitor. In one embodiment, sampling the voltage at the first end of the resonant capacitor comprises coupling a second end of the resonant capacitor to the second primary winding (i.e. a sampling winding) and sampling the voltage at the first end of the resonant capacitor through the second primary winding, a second end of the second primary winding provides a capacitor voltage sampling signal.

At step S12, providing an AC sampling signal based on the voltage at the first end of the resonant capacitor. In one embodiment, providing the AC sampling signal based on the voltage at the first end of the resonant capacitor further comprises filtering out DC component in the capacitor voltage sampling signal by a high pass filtering circuit. In one embodiment, providing the AC sampling signal based on the voltage at the first end of the resonant capacitor further comprises receiving a voltage signal at the first end of the resonant capacitor and performing high pass filtering on the voltage signal to provide the AC sampling signal.

In step S13, limiting a negative voltage portion of the AC sampling signal to be not less than a threshold, and providing a current sensing signal to a controller of the resonant converter. In one embodiment, the threshold is, for example, close to or equal to zero voltage.

It is noted that the order of execution of the steps in the above-described flowchart is not limited to that shown in FIG. 12, and two sequential blocks may be executed simultaneously or in the reverse order.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A resonant converter, comprising:
a first transistor, a second transistor, a third transistor and a fourth transistor, each of the first, second, third and fourth transistors having a first end and a second end, wherein the first end of the first transistor and the first end of the third transistor are coupled to a DC input voltage, the second end of the first transistor is coupled to the first end of the second transistor to form a first switching node, and the second end of the third transistor is coupled to the first end of the fourth transistor to form a second switching node;
a transformer comprising a primary winding and a first sampling winding at a primary side, and a secondary winding at a secondary side, wherein each of the primary winding, the first sampling winding and the secondary winding has a first end and a second end;
a resonant tank circuit comprising a resonant capacitor, a resonant inductor and a magnetizing inductance of the primary winding coupled in series, wherein the resonant tank circuit is coupled between the first switching node and the second switching node, the resonant capacitor has a first end and a second end, the first end of the resonant capacitor is coupled to the first end of the first sampling winding, the second end of the resonant capacitor is coupled to the first switching node, and the second end of the first sampling winding is configured to provide a first capacitor voltage sampling signal;
a rectifier circuit coupled between the first end of the secondary winding and the second end of the secondary winding; and
a current sensing circuit configured to receive the first capacitor voltage sampling signal and provide a current sensing signal based on the first capacitor voltage sampling signal; wherein
a portion of the current sensing signal greater than a threshold indicates a current flowing through the resonant tank circuit.

2. The resonant converter of claim 1, wherein:
the rectifier circuit comprises a fifth transistor and a sixth transistor, each of the fifth and sixth transistors having a first end and a second end, wherein the first end of the fifth transistor is coupled to the first end of the secondary winding, the first end of the sixth transistor is coupled to the second end of the secondary winding, and the second end of the fifth transistor and the second end of the sixth transistor are coupled to a reference ground; and wherein
the first end of the secondary winding is coupled to the second end of the second transistor, and the second end of the secondary winding is coupled to the second end of the fourth transistor, the secondary winding has a center-tap which divides the secondary winding into two portions, and the center-tap is configured as an output node to provide an output voltage of the resonant converter.

3. The resonant converter of claim 1, wherein the current sensing circuit comprises:
a high pass filtering circuit comprises a first filter capacitor and a first filter resistor coupled in series, the first filter capacitor is coupled to the second end of the first sampling winding to receive the first capacitor voltage sampling signal, and the first filter resistor is coupled to a reference ground, and the high pass filtering circuit is configured to receive the first capacitor voltage sampling signal representing a voltage at the first end of the resonant capacitor via the first filter capacitor, and to provide a first AC sampling signal; and
a negative clamping circuit coupled to the output end of the high pass filtering circuit to receive the first AC sampling signal, and provide a first current sensing signal via limiting a negative voltage portion of the first AC sampling signal to be not less than the threshold.

4. The resonant converter of claim 3, wherein the negative clamping circuit comprises a first sensing transistor, the first sensing transistor has a first end and a second end, the first end of the first sensing transistor is coupled to the output end of the high pass filtering circuit, and the second end of the first sensing transistor is coupled to the reference ground.

5. The resonant converter of claim 4, wherein the first sensing transistor further comprises a control end, and the resonant converter is configured to control turn-on and turn-off of the first sensing transistor via the control end of the first sensing transistor based on switching states of the first transistor and the fourth transistor.

6. The resonant converter of claim 3, wherein the negative clamping circuit comprises a diode, and an anode of the diode is coupled to the output end of the first high pass filtering circuit and a cathode of the diode is configured to provide the first current sensing signal.

7. The resonant converter of claim 1, wherein:
the transformer further comprises a second sampling winding having a first end and a second end, wherein a number of turns of the second sampling winding is equal to a number of turns of the first sampling winding, the first end of the second sampling winding is coupled to the second end of the resonant capacitor, and the second end of the second sampling winding is configured to provide a second capacitor voltage sampling signal; and wherein
the current sensing circuit is further configured to receive the second capacitor voltage sampling signal and provide the current sensing signal based on the first capacitor voltage sampling signal and the second capacitor voltage sampling signal.

8. The resonant converter of claim 7, wherein the current sensing circuit comprises:
a first high pass filtering circuit configured to perform high pass filtering on the first capacitor voltage sampling signal to provide a first AC sampling signal;
a second high pass filtering circuit configured to perform high pass filtering on the second capacitor voltage sampling signal to provide a second AC sampling signal; and wherein
a negative clamping circuit configured to receive the first AC sampling signal and the second AC sampling signal, and configured to provide the current sensing signal via limiting a negative voltage portion of a differential signal of the first AC sampling signal and the second AC sampling signal to be not less than the threshold.

9. A resonant converter, comprising:
a first transistor, a second transistor, a third transistor and a fourth transistor, each of the first, second, third and fourth transistors having a first end and a second end, wherein the first end of the first transistor and the first end of the third transistor are coupled to a DC input voltage, the second end of the first transistor is coupled to the first end of the second transistor to form a first switching node, and the second end of the third transistor is coupled to the first end of the fourth transistor to form a second switching node;
a transformer comprising a first primary winding, a second primary winding, and a secondary winding, wherein each of the first primary winding, the second primary winding and the secondary winding has a first end and a second end, the first end of the secondary winding is coupled to the second end of the second transistor, and the second end of the secondary winding is coupled to the second end of the fourth transistor;
a resonant tank circuit comprising a resonant capacitor, a magnetizing inductance of the first primary winding, a magnetizing inductance of the second primary winding, a first resonant inductor, and a second resonant inductor, wherein the resonant capacitor has a first end and a second end, the first resonant inductor and the first primary winding are coupled in series between the first switching node and the first end of the resonant capacitor, and the second resonant inductor and the second primary winding are coupled in series between the second switching node and the second end of the resonant capacitor;
a rectifier circuit coupled between the first end of the secondary winding and the second end of the secondary winding; and
a current sensing circuit configured to receive a voltage at the first end of the resonant capacitor, perform high pass filtering on the voltage at the first end of the resonant capacitor to provide a high pass filtered signal, and configured to provide a first current sensing signal via limiting a negative voltage of the high pass filtered signal to be not less than a first threshold; wherein
a portion of the first current sensing signal greater than the first threshold indicates a current flowing through the resonant tank circuit.

10. The resonant converter of claim 9, wherein:
the rectifier circuit comprises a fifth transistor and a sixth transistor, each of the fifth and sixth transistors having a first end and a second end, wherein the first end of the fifth transistor is coupled to the first end of the secondary winding, the first end of the sixth transistor is coupled to the second end of the secondary winding, and the second end of the fifth transistor and the second end of the sixth transistor are coupled to a reference ground; and wherein
the secondary winding has a center-tap which divides the secondary winding into two portions, and the center-tap is configured as an output node to provide an output voltage of the resonant converter.

11. The resonant converter of claim 9 wherein an DC bias of the voltage at the first end of the resonant capacitor is equal to an DC bias of a voltage at the second end of the resonant capacitor.

12. The resonant converter of claim 9, wherein the current sensing circuit comprises:
a first high pass filtering circuit comprising a first filter capacitor and a first filter resistor coupled in series, wherein the first filter capacitor is coupled to the first end of the resonant capacitor, and the first filter resistor is coupled to a reference ground, and an output end of the first high pass filtering circuit is configured to provide a first AC sampling signal after performing high pass filtering; and
a first negative clamping circuit configured to receive the first AC sampling signal, and configured to provide a first current sensing signal via limiting the negative voltage portion of the first AC sampling signal to be not less than the first threshold.

13. The resonant converter of claim 12, wherein:
the first negative clamping circuit comprises a first sensing transistor, the first sensing transistor has a first end and a second end, the first end of the first sensing transistor is coupled to the output end of the first high pass filtering circuit, and the second end of the first sensing transistor is coupled to the reference ground; and wherein
the resonant converter is configured to control turn-on and turn-off of the first sensing transistor based on switching states of the second transistor and the third transistor.

14. The resonant converter of claim 9, wherein:
the current sensing circuit is further configured to receive a voltage at the second end of the resonant capacitor, perform high pass filtering on the voltage at the second end of the resonant capacitor to provide a high pass filtered signal, and configured to provide a second current sensing signal via limiting the negative voltage portion of the high pass filtered signal to be not less than a second threshold; and wherein
a portion of the second current sensing signal greater than the second threshold characterizes the current flowing through the resonant tank circuit.

15. A resonant converter, comprising:
a first transistor, a second transistor, a third transistor and a fourth transistor, each of the first, second, third and fourth transistors having a first end and a second end, wherein the first end of the first transistor and the first end of the third transistor are coupled to a DC input voltage, the second end of the first transistor is coupled to the first end of the second transistor to form a first switching node, and the second end of the third transistor is coupled to the first end of the fourth transistor to form a second switching node;
a transformer comprising a first primary winding, a second primary winding, and a secondary winding, wherein each of the primary winding, the second primary winding, and the secondary winding has a first end and a second end, the first end of the secondary winding is coupled to the second end of the second transistor, and the second end of the secondary winding is coupled to the second end of the fourth transistor;
a resonant tank circuit comprising a resonant inductor, a resonant capacitor and a magnetizing inductance of the first primary winding coupled in series, the resonant tank circuit is coupled between the first switching node and the second switching node, the resonant capacitor has a first end and a second end, wherein the first end of the resonant capacitor is coupled to the first primary winding;
a rectifier circuit coupled between the first end of the secondary winding and the second end of the secondary winding; and
a current sensing circuit configured to provide a current sensing signal based on a voltage at the first end of the resonant capacitor, the current sensing signal characterizes a current flowing through the resonant tank circuit; wherein
a portion of the current sensing signal greater than a threshold indicates a magnitude of a current flowing through the resonant tank circuit.

16. The resonant converter of claim 15, wherein:
the rectifier circuit comprises a fifth transistor and a sixth transistor, each of the fifth and six transistors having a first end and a second end, wherein the first end of the fifth transistor is coupled to the first end of the secondary winding, the first end of the sixth transistor is coupled to the second end of the secondary winding, and the second end of the fifth transistor and the second end of the sixth transistor are coupled to a reference ground; and wherein
the secondary winding has a center-tap, which divides the secondary winding into two portions, and the center-tap is configured as an output node to provide an output voltage of the resonant converter.

17. The resonant converter of claim 15, wherein the current sensing circuit comprises:
a high pass filtering circuit, comprising a filter capacitor and a filter resistor coupled in series, wherein the filter resistor is coupled to a reference ground, and the high pass filtering circuit is configured to sample the voltage at the first end of the resonant capacitor and provide a high pass filtered AC sampling signal; and
a negative clamping circuit configured to receive the AC sampling signal, and configured to provide the current sensing signal via limiting a negative voltage portion of the AC sampling signal to be not less than the threshold.

18. The resonant converter of claim 15, wherein:
the resonant tank circuit further comprises a second primary winding and a second resonant inductor of the transformer, wherein the first resonant inductor and the first primary winding are coupled in series between the first switching node and the first end of the resonant capacitor, the second resonant inductor and the second primary winding are coupled in series between the second switching node and the second end of the resonant capacitor, and an DC bias of the voltage at the first end of the resonant capacitor is equal to an DC bias of a voltage at the second end of the resonant capacitor; and wherein
the current sensing circuit is coupled to the first end of the resonant capacitor to provide the current sensing signal.

19. The resonant converter of claim 15, wherein:
the second end of the resonant capacitor is coupled to the first switching node, and the second end of the second primary winding is configured to provide a first capacitor voltage sampling signal; and wherein
the current sensing circuit is coupled to the second end of the second primary winding to receive the first capacitor voltage sampling signal and provide the current sensing signal.

20. The resonant converter of claim 15, wherein the current sensing circuit is further configured to provide the current sensing signal based on a voltage at the second end of the resonant capacitor, the current sensing circuit comprising:
a first high pass filtering circuit, comprising a first filter capacitor and a first filter resistor coupled in series, wherein the first filter resistor is coupled to a reference ground, and the first high pass filtering circuit is configured to sample the voltage at the first end of the resonant capacitor and provide a high pass filtered first AC sampling signal;
a second high pass filtering circuit comprising a second filter capacitor and a second filter resistor coupled in series, wherein the second filter resistor is coupled to the reference ground, and the second high pass filtering circuit is configured to sample a voltage at the second end of the resonant capacitor and provide a high pass filtered second AC sampling signal; and
a negative clamping circuit configured to receive the first AC sampling signal and the second AC sampling signal, and configured to provide the current sensing signal via limiting a negative voltage portion of a differential signal of the first AC sampling signal and the second AC sampling signal to be not less than the threshold.
